(19) United States
(12) Patent Application Publication
(10) Pub. No.: US 2017/0270714 A1
(43) Pub. Date: Sep. 21, 2017

(54) VIRTUAL REALITY AND AUGMENTED REALITY DEVICE

(71) Applicant: BOE TECHNOLOGY GROUP CO., LTD., Beijing (CN)

(72) Inventor: Defeng MAO, Beijing (CN)

(73) Assignee: BOE TECHNOLOGY GROUP CO., LTD., Beijing (CN)

(21) Appl. No.: 15/283,678

(22) Filed: Oct. 3, 2016

(30) Foreign Application Priority Data
Mar. 17, 2016 (CN) 201610154391.1

(51) Int. Cl. G06T 19/00; G09G 5/12; G09G 5/14

(52) U.S. Cl. CPC G06T 19/006; G09G 5/14; G09G 5/12; G09G 2354/00

(57) ABSTRACT

The present disclosure provides a virtual reality and augmented reality device. The device includes a virtual reality module, an augmented reality module and a communication module. The communication module is connected to the virtual reality module and the augmented reality module. The virtual reality module and/or the augmented reality module may transmit a communication instruction to the communication module in the case of identifying a first preset operation, such that the communication module receives a message, transmits a message, or receives the message and transmits the message.

### CROSS-REFERENCE TO RELATED APPLICATIONS

This application claims priority to Chinese application No. 20161015439.1, filed Mar. 17, 2016, which is hereby incorporated by reference in its entirety.

### TECHNICAL FIELD

The present disclosure relates to the technical field of virtual reality, and in particular to a virtual reality and augmented reality device.

### BACKGROUND

At present, an augmented reality (AR) system and a virtual reality (VR) system become more and more popular in market, and interactions between a user and a virtual environment can be improved with the VR system and the AR system. However, the user still needs to make a phone call or receive a message via a mobile phone since the existing VR and AR device has no communication function.

In a virtual environment, for example, if a user wears VR glasses, the user needs to take off the VR glasses to find his/her mobile phone when a call is coming or a message is received by the mobile phone, thereby reducing a usage experience of the user on the VR device. In addition, both the mobile phone with the communication function and the AR/VR device have to be carried by the user, such that the load is increased.

### SUMMARY

A technical problem to be solved by the present disclosure lies in how to integrate a communication function into a virtual reality and augmented reality device.

In view of this, the present disclosure provides in some embodiments a virtual reality and augmented reality device, which includes: a virtual reality module, an augmented reality module and a communication module. The communication module is connected to the virtual reality module and the augmented reality module. The virtual reality module, the augmented reality module, or both of the virtual reality module and the augmented reality module transmit a communication instruction to the communication module in the case of identifying a first preset operation, such that the communication module receives a message, transmits a message, or receives a message and transmits a message.

Optionally, the virtual reality module may comprise a first identification sub-module connected to the communication module, and the first identification sub-module is configured to identify an operation of a user and transmit a communication instruction to the communication module in the case of identifying a first preset operation of the user. The augmented reality module comprises a second identification sub-module connected to the communication module, and the second identification sub-module is configured to identify an operation of a user and transmit a communication instruction to the communication module in the case of identifying the first preset operation.

Optionally, the virtual reality and augmented reality device may be a head-mounted device comprising a main body and a lens connected to the main body. The virtual reality module comprises a first display sub-module arranged on the lens, and the first display sub-module is configured to display a content and control the content to be displayed according to the identified operation of the user. The augmented reality module comprises a second display sub-module arranged on the lens, and the second display sub-module is configured to display a content and control the content to be displayed according to the identified operation of the user.

Optionally, the above device may further include: a switching module, wherein the switching module is connected to the lens and configured to control the lens to display the content corresponding to the first display sub-module or the content corresponding to the second display sub-module.

Optionally, the lens may include a first sub-lens and a second sub-lens, the first display sub-module is arranged on the first sub-lens and the second display sub-module is arranged on the second sub-lens.

Optionally, the device may further include a switching module, wherein the switching module is connected to the first sub-lens and the second sub-lens, and configured to adjust the first sub-lens or the second sub-lens to be at a location corresponding to human eyes.

Optionally, the device may further include an image acquisition module. The image acquisition module is connected to the first identification sub-module, the second identification sub-module, or both of the first identification sub-module and the second identification sub-module, and configured to acquire a real environment image in the case of receiving an acquisition instruction. The first identification sub-module, the second identification sub-module, or both of the first identification sub-module and the second identification sub-module transmit the acquisition instruction to the image acquisition module in the case of identifying the second preset operation.

Optionally, the image acquisition module is connected to the first display sub-module and the second display sub-module, and further configured to acquire a real environment image and an image corresponding to the first display sub-module, and a real environment image and an image corresponding to the second display sub-module. The device may further comprise an integration module, wherein the integration module is configured to integrate the real environment image and the image corresponding to the first display sub-module, and integrate the real environment image and the image corresponding to the second display sub-module.

Optionally, the communication module may be arranged in the main body.

Optionally, the device may further include: a verification module, wherein the verification module is connected to the virtual reality module, the augmented reality module or both of the virtual reality module and the augmented reality module, and configured to verify an identity of the user, and transmit a start signal to the virtual reality module, the augmented reality module or both of the virtual reality module and the augmented reality module in a case that the identity of the user is verified to be valid.

Optionally, the message may include one or more of a voice message, a video message, an image message and a text message.

In the technical solutions according to the above embodiments, instructions may be transmitted to the communication module via the virtual reality module and/or the augmented reality module, and the message is received and transmitted via the communications module. In this case, a user can communicate and receive/transmit a message directly in a virtual environment if desired when the user uses the virtual reality module and/or augmented reality module. In addition, the communication module, the virtual reality module and the augmented reality module are easy to be carried since they are arranged in the same device.

### DESCRIPTION OF THE DRAWINGS

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

FIG. 1 shows a schematic block diagram of a virtual reality and augmented reality device according to an embodiment of the present disclosure;

FIG. 2 shows a schematic diagram of a head-mounted device according to an embodiment of the present disclosure; and

FIG. 3 shows a schematic diagram of a head-mounted device according to an embodiment of the present disclosure.

### DETAILED DESCRIPTION

As required, detailed embodiments are disclosed herein. However, it is to be understood that the disclosed embodiments are merely exemplary and that various and alternative forms may be employed. The figures are not necessarily to scale. Some features may be exaggerated or minimized to show details of particular components. Therefore, specific structural and functional details disclosed herein are not to be interpreted as limiting, but merely as a representative basis for teaching one skilled in the art.

The present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “a” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

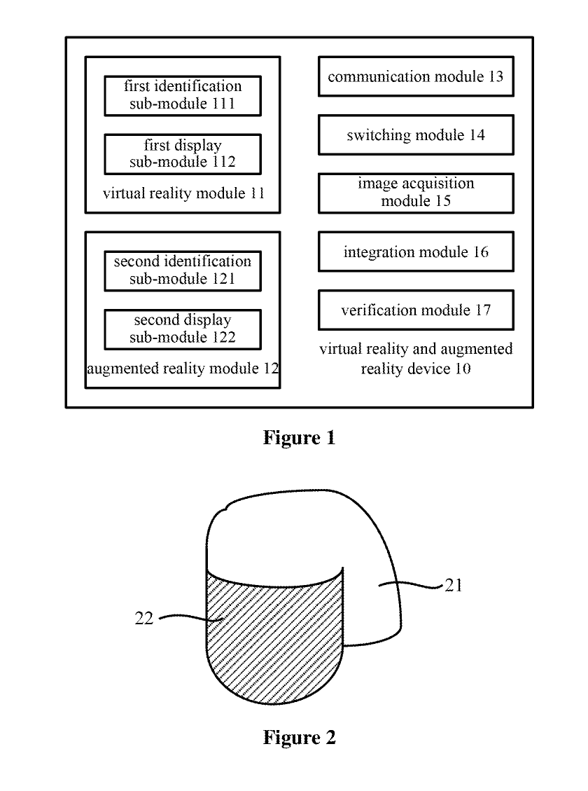

As shown in FIG. 1, in an embodiment of the present disclosure, a virtual reality and augmented reality device 10 includes a virtual reality module 11, an augmented reality module 12 and a communication module 13.

Specifically, the communication module 13 is connected (in a wired or wireless manner) to the virtual reality module 11 and the augmented reality module 12. The virtual reality module 11 and/or the augmented reality module 12 transmits a communication instruction to the communication module 13 in the case of identifying a first preset operation, such that the communication module 13 receives and/or transmits the message.

Instructions may be transmitted to the communication module via the virtual reality module and/or the augmented reality module, and then the message is received and transmitted by the communication module. In this case, when using the virtual reality module and/or the augmented reality module, a user may communicate and receive/transmit message directly in a virtual environment if desired.

For example, if the virtual reality module is used for playing a game and a WeChat voice message is received by the communication module, the message may be transmitted to a virtual scenario where the game is current in, and is played to the user. Alternatively an alert may be displayed in the virtual scenario, and based on which the user can determine whether to listen to the message). The user may reply the message with an instruction (for example, a voice instruction), and the instruction is transmitted via the communication module. In this embodiment, the first preset operation may be the voice instruction, an eyeball movement, a limb action or the like, or a combination thereof. In addition, the communication module, the virtual reality module and the augmented reality module are easy to be carried since they are in the same device.

The above message includes a voice message, a video message, an image message, a text message or the like. Further, the communication module may achieve an Internet access function through a baseband chip or a radio frequency chip.

In this embodiment, the virtual reality module may be a computer simulation system for creating, by a computer, a virtual environment to be experienced, which is a system of merging multi-source information and integrating interactive three-dimensional dynamic visions and actual activities. The user may completely immerse into the virtual environment and does not interact with a real environment. Optionally, a virtual reality display portion may display in an enclosed manner, and the display medium may be a Liquid Crystal Display (LCD), an Organic Light Emitting Diode (OLED) display, a plasma display or the like. A flexible display such as the OLED display may be selected to fit a facial contour optimally.

The augmented reality module may project content onto a prism through a projection system. In this way, the content on the prism can be seen by the user. For example, in this embodiment, the augmented reality module may include a Google Glass. Alternatively, various information and data acquired by a camera or the like may be processed by a Central Processing Unit (CPU) and a Graphic Processing Unit (GPU) which have good performances, and then a virtual object may be created through laminated color lenses by means of a Holographic Processing Unit (HPU). For example, the augmented reality module may be Microsoft's Hololens. Optionally, an image may be projected onto the user's retina through a micro-projector and a semitransparent prism. For example, ESPON's MOVERIO BT-200 intelligent glasses may be adopted as the augmented reality module.

Optionally, the virtual reality module 11 may include a first identification sub-module 111 connected to the communication module 13, and the first identification sub-module 111 is configured to identify an operation of a user and transmit a communication instruction to the communication module 13 in the case of identifying a first preset operation of the user. The augmented reality module 12 may include a second identification sub-module 121 connected to the communication module 13, and the second identification sub-module 121 is configured to identify an operation of a user and transmit a communication instruction to the communication module 13 in the case of identifying the first preset operation.

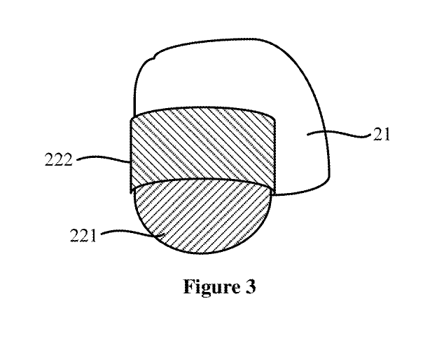

Optionally, as shown in FIG. 2, the device 10 may be a head-mounted device including a main body 21 and a lens 22 connected to the main body 21.

The virtual reality module 11 may include a first display sub-module 112 arranged on the lens 22, and the first display sub-module 112 is configured to display a content and control the content to be displayed according to the identified operation of the user. The augmented reality module 12 may include a second display sub-module 122 arranged on the lens 22, and the second display sub-module 122 is configured to display a content and control the content to be displayed according to the identified operation of the user.

In this embodiment, both of the virtual reality module and the augmented reality module may display virtual scenarios by means of the lens of the head-mounted device.

The first identification sub-module and the second identification sub-module may be arranged on the main body or the lens.

The first identification sub-module and the second identification sub-module include a pupilla identification element, an iris identification element, a voice identification element, an action identification element and the like, so as to identify the first preset operation.

According to this embodiment, in the case that the virtual reality module is used, the first identification sub-module identifies the operation of the user. If the user intends to carry out a communication, the user may perform the first preset operation, such as speaking out the voice “making a call”, thereby to enable the first identification sub-module to transmit a communication instruction to the communication module, and thus achieve the communication. In a case that the augmented reality module is used, a similar process may be implemented.

Optionally, the above device 10 may further include a switching module 14, where the switching module 14 is connected to the lens 22 and configured to control the lens 22 to display a content corresponding to the first display sub-module 112 or display a content corresponding to the second display sub-module 122. The switching module may be arranged on the main body or the lens.

According to the embodiment, in a case that the virtual reality module or the augmented reality module is used by user, the user may switch to display between the virtual environment of the virtual reality module and the virtual environment of the augmented reality module on the lens as required, thereby to facilitate a switching between the virtual reality module and the augmented reality module.

An instruction for the switching module may be inputted via a virtual button on the lens, or may be inputted via a mechanical button on the main body. Alternatively, the input operation may be identified by the first identification sub-module and/or the second identification sub-module.

Optionally, as shown in FIG. 3, the lens may include a first sub-lens 221 and a second sub-lens 222. The first display sub-module 112 may be arranged on the first sub-lens 221, and the second display sub-module 122 may be arranged on the second sub-lens 222.

In this embodiment, virtual environments of the virtual reality module and the augmented reality module may be displayed respectively via the two sub-lenses. Since the sub-lenses are connected to the display sub-modules respectively, the circuit is simple and easy to be designed.

Optionally, the above device 10 may further include a switching module 14, wherein the switching module 14 is connected to the first sub-lens 221 and the second sub-lens 222 and is configured to adjust the first sub-lens 221 and the second sub-lens 222 to be at a location corresponding to the human eyes.

According to this embodiment, in a case that the virtual reality module or the augmented reality module is used by user, the user may switch the lens to display between the virtual environment of the virtual reality module and the virtual environment of the augmented reality module as required, thereby to facilitate a switching between the virtual reality module and the augmented reality module.

An instruction for the switching module may be inputted by means of the virtual button on the lens or inputted by means of the mechanical button on the main body. Alternatively, the instruction may be inputted by the first identification sub-module and/or the second identification sub-module.

Of course, the user may adjust the first sub-lens and/or the second sub-lens manually as required. For example, if the first sub-lens and the second sub-lens are respectively two layers of goggles at the front end of the main body, the user may retract one of two sub-lenses. Each of the two sub-lenses may be in a display state or a non-display state. The sub-lens is transparent in the case of being in the non-display state.

Optionally, the above device 10 may further include an image acquisition module 15 connected to the first identification sub-module 111 and/or the second identification sub-module 121. The image acquisition module 15 acquires a real environment image in the case of receiving an acquisition instruction. The first identification sub-module 111 and/or the second identification sub-module 121 may transmit an acquisition instruction to the image acquisition module 15 in the case of identifying a second preset operation.

In this embodiment, the image acquisition module may be arranged on the main body or the lens.

According to the embodiment, an instruction may be transmitted to the image acquisition module by means of the virtual reality module and/or the augmented reality module, thereby to achieve an image acquisition through the image acquisition module. In the case that the user uses the virtual reality module and/or the augmented reality module, an image can be directly acquired in a virtual environment if the image acquisition is required, thereby to achieve the image acquisition operation accordingly.

Optionally, the image acquisition module 15 may be connected to the first display sub-module 112 and the second display sub-module 122. The image acquisition module 15 may be further configured to acquire the image and the real environment image corresponding to the first display sub-module 112 and acquire the image and the real environment image corresponding to the second display sub-module 122.

The above device 10 may further include an integration module 16. The integration module 16 is configured to integrate the image corresponding to the first display sub-module 112 with the real environment image, and integrate the image corresponding to the second display sub-module 122 with the real environment image.

According to this embodiment, a real environment image and a virtual environment image in the first display sub-module may be acquired simultaneously, and a real environment image and a virtual environment image in the second display sub-module may be acquired simultaneously. Then, the virtual environment image may be integrated with the real environment image, so as to display the real environment image in the virtual environment, and display the virtual environment image in the real environment image, thereby to generate an image by integrating the virtual environment being experienced by the user with the real environment where the user is actually located.

Optionally, the communication module 13 may be arranged in the main body 21.

In this embodiment, the communication module is arranged in the main body, and the virtual reality module and the augmented reality module are arranged in the lens and/or main body. In this case, all of the communication module, the virtual reality module and the augmented reality module are arranged on the head-mounted device, and are easy to be carried.

Optionally, the above device 10 may further include a verification module 17. The verification module 17 is connected to the virtual reality module 11 and/or the augmented reality module 12, and is configured to verify an identity of a user and transmit a start signal to the virtual reality module 11 and/or the augmented reality module 12 in a case that the identity of user is verified to be valid.

According to the embodiment, an identity of the user using the virtual reality module and/or the augmented reality module may be verified, so as to prevent information of the virtual reality module and/or the augmented reality module from being stolen.

For example, in the case that the user uses the above device, a Subscriber Identity Module (SIM) card may be inserted into the device, so that the verification module may verify the identity of the user.

The above device may further include a memory unit such as Read-Only Memory (ROM). The memory unit is configured to store data generated during a process of using the virtual reality module and/or the augmented reality module, and data generated during a process of using the communication module.

In the above, the technical solutions of the present disclosure are described in detail in conjunction with the drawings. In the related art, it is difficult for the user to communicate effectively in the case of using the virtual reality and augmented reality device. In the technical solutions according to the embodiments of the present disclosure, the instruction may be transmitted to the communication module by means of the virtual reality module and/or the augmented reality module, thereby to receive and transmit the message via the communication module. Therefore, in the case that the user uses the virtual reality module and/or the augmented reality module, the communication can be directly performed in the virtual environment if the communication is required, and the message can be received or transmitted. In addition, the communication module, the virtual reality module and the augmented reality module are easy to be carried since they are arranged in the same device.

The above are merely the preferred embodiments of the present disclosure. Obviously, a person skilled in the art may make further modifications and improvements without departing from the spirit of the present disclosure, and these modifications and improvements shall also fall within the scope of the present disclosure.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A virtual reality and augmented reality device, comprising: a virtual reality module, an augmented reality module and a communication module, wherein
the communication module is connected to the virtual reality module and the augmented reality module,
the virtual reality module, the augmented reality module, or both of the virtual reality module and the augmented reality module transmit a communication instruction to the communication module in the case of identifying a first preset operation, such that the communication module receives a message, transmits a message, or receives the message and transmits the message.

2. The device according to claim 1, wherein
the virtual reality module comprises a first identification sub-module connected to the communication module, and the first identification sub-module is configured to identify an operation of a user, and transmit the communication instruction to the communication module in the case of identifying the first preset operation of the user; and
the augmented reality module comprises a second identification sub-module connected to the communication module, and the second identification sub-module is configured to identify the operation of the user, and transmit the communication instruction to the communication module in the case of identifying the first preset operation.

3. The device according to claim 2, wherein the virtual reality and augmented reality device is a head-mounted device comprising a main body and a lens connected to the main body, wherein
the virtual reality module comprises a first display sub-module arranged on the lens, and the first display sub-module is configured to display a content, and control the content to be displayed according to the identified operation of the user; and
the augmented reality module comprises a second display sub-module arranged on the lens, and the second display sub-module is configured to display a content, and control the content to be displayed according to the identified operation of the user.

4. The device according to claim 3, further comprising:
a switching module, wherein the switching module is connected to the lens, and configured to control the lens to display the content corresponding to the first display sub-module or the content corresponding to the second display sub-module.

5. The device according to claim 3, wherein the lens comprises a first sub-lens and a second sub-lens, the first display sub-module is arranged on the first sub-lens, and the second display sub-module is arranged on the second sub-lens.

6. The device according to claim 5, further comprising:
a switching module, wherein the switching module is connected to the first sub-lens and the second sub-lens, and configured to adjust the first sub-lens or the second sub-lens to be at a location corresponding to human eyes.

7. The device according to claim 3, further comprising:
an image acquisition module, wherein the image acquisition module is connected to the first identification sub-module, the second identification sub-module, or both of the first identification sub-module and the second identification sub-module, and configured to acquire a real environment image in the case of receiving an acquisition instruction,
wherein the first identification sub-module, the second identification sub-module, or both of the first identification sub-module and the second identification sub-module transmit the acquisition instruction to the image acquisition module in the case of identifying a second preset operation.

8. The device according to claim 4, further comprising:
an image acquisition module, wherein the image acquisition module is connected to the first identification sub-module, the second identification sub-module, or both of the first identification sub-module and the second identification sub-module, and configured to acquire a real environment image in the case of receiving an acquisition instruction,
wherein the first identification sub-module, the second identification sub-module, or both of the first identification sub-module and the second identification sub-module transmit the acquisition instruction to the image acquisition module in the case of identifying a second preset operation.

9. The device according to claim 5, further comprising:
an image acquisition module, wherein the image acquisition module is connected to the first identification sub-module, the second identification sub-module, or both of the first identification sub-module and the second identification sub-module, and configured to acquire a real environment image in the case of receiving an acquisition instruction,
wherein the first identification sub-module, the second identification sub-module, or both of the first identification sub-module and the second identification sub-module transmit the acquisition instruction to the image acquisition module in the case of identifying a second preset operation.

10. The device according to claim 6, further comprising:
an image acquisition module, wherein the image acquisition module is connected to the first identification sub-module, the second identification sub-module, or both of the first identification sub-module and the second identification sub-module, and configured to acquire a real environment image in the case of receiving an acquisition instruction,
wherein the first identification sub-module, the second identification sub-module, or both of the first identification sub-module and the second identification sub-module transmit the acquisition instruction to the image acquisition module in the case of identifying a second preset operation.

11. The device according to claim 7, wherein the image acquisition module is connected to the first display sub-module and the second display sub-module, and further configured to acquire a real environment image and an image corresponding to the first display sub-module, and a real environment image and an image corresponding to the second display sub-module; and
the device further comprises an integration module, wherein the integration module is configured to integrate the real environment image and the image corresponding to the first display sub-module, and integrate the real environment image and the image corresponding to the second display sub-module.

12. The device according to claim 3, wherein the communication module is arranged in the main body.

13. The device according to claim 4, wherein the communication device is arranged in the main body.

14. The device according to claim 1, further comprising:
a verification module, wherein the verification module is connected to the virtual reality module, the augmented reality module or both of the virtual reality module and the augmented reality module, and configured to verify an identity of the user, and transmit a start signal to the virtual reality module, the augmented reality module or both of the virtual reality module and the augmented reality module in a case that the identity of the user is verified to be valid.

15. The device according to claim 2, further comprising:
a verification module, wherein the verification module is connected to the virtual reality module, the augmented reality module or both of the virtual reality module and the augmented reality module, and configured to verify an identity of the user, and transmit a start signal to the virtual reality module, the augmented reality module or both of the virtual reality module and the augmented reality module in a case that the identity of the user is verified to be valid.

16. The device according to claim 3, further comprising:
a verification module, wherein the verification module is connected to the virtual reality module, the augmented reality module or both of the virtual reality module and the augmented reality module, and configured to verify an identity of the user, and transmit a start signal to the virtual reality module, the augmented reality module or both of the virtual reality module and the augmented reality module in a case that the identity of the user is verified to be valid.

17. The device according to claim 4, further comprising:
a verification module, wherein the verification module is connected to the virtual reality module, the augmented reality module or both of the virtual reality module and the augmented reality module, and configured to verify an identity of the user, and transmit a start signal to the virtual reality module, the augmented reality module or both of the virtual reality module and the augmented reality module in a case that the identity of the user is verified to be valid.

18. The device according to claim 5, further comprising:
a verification module, wherein the verification module is connected to the virtual reality module, the augmented reality module or both of the virtual reality module and the augmented reality module, and configured to verify an identity of the user, and transmit a start signal to the virtual reality module, the augmented reality module or both of the virtual reality module and the augmented reality module in a case that the identity of the user is verified to be valid.

19. The device according to claim 6, further comprising:
a verification module, wherein the verification module is connected to the virtual reality module, the augmented reality module or both of the virtual reality module and the augmented reality module, and configured to verify an identity of the user, and transmit a start signal to the virtual reality module, the augmented reality module or both of the virtual reality module and the augmented reality module in a case that the identity of the user is verified to be valid.

20. The device according to claim 1, wherein the message comprises one or more of a voice message, a video message, an image message and a text message.
